(19) United States
(12) Patent Application Publication
(10) Pub. No.: US 2026/0112863 A1
(43) Pub. Date: Apr. 23, 2026

(54) Medium-voltage distribution switchboard

(71) Applicant: Schneider Electric Industries SAS, Rueil Malmaison (FR)

(72) Inventors: Philippe Brun, Bernin (FR); Venanzio Ferraro, Grenoble (FR)

(21) Appl. No.: 19/362,045

(22) Filed: Oct. 17, 2025

(30) Foreign Application Priority Data
Oct. 22, 2024 (FR) FR2411532

(51) Int. Cl. H02B 1/04; H02B 1/24

(52) U.S. Cl. CPC H02B 1/04; H02B 1/24

(57) ABSTRACT

Proposed is a medium-voltage distribution switchboard (100), comprising:
a set of cells (10-A, 10-B),
a central unit (1) connected to two communication buses (B1, B2) and configured to deliver a switching request asking for current to be switched, each cell (10-A,10-B) respectively comprising:
a first sensor (5-A, 5-B) configured to measure a first physical parameter representative of the electrical current,
an interface unit (2-A, 2-B) connected to the first bus (B1) and configured to deliver the signal of the first sensor (5-A, 5-B) to the central unit (1),
a second sensor (6-A, 6-B) configured to measure a second physical parameter representative of operating conditions of the cell (10-A, 10-B),
an acquisition unit (3-A, 3-B) connected to the second bus (B2) and configured to deliver the signal of the second sensor (6-A, 6-B) to the central unit (1), the interface unit (2-A, 2-B) being configured to switch the current of the cell (10-A, 10-B) on receipt of the switching request.

### TECHNICAL FIELD

The present invention relates to the field of medium-voltage electrical distribution systems, i.e. for which the nominal operating voltage is between 1 kV and 52 kV. These distribution systems are integrated in a medium-voltage electrical distribution network.

### PRIOR ART

A medium-voltage electrical distribution system comprises a set of branches interconnected by a distribution switchboard. Such a distribution switchboard thus comprises a set of electrical cells, each cell providing for powering at least one of the branches. The electrical network can be configured according to requirements, by the arrangement of a set of cells.

Each cell is equipped in particular with a circuit breaker, in order to be able to switch the current in this cell in the event of an operating fault, for example in the event of a short-circuit between a phase and earth. Each cell thus comprises various sensors for measuring various physical quantities that are characteristic of the operation of the cell, and a processing unit for processing the measured data. By analysing the measured data, a fault in the monitored branch can be diagnosed, and a switching of the current in the monitored branch can be triggered in the event that a fault is detected. Generally, each cell is equipped with sensors and a processing unit that are specific to the part of the electrical network powered by this cell. Each cell is thus specific to the usage originally planned for.

As such, the design of a distribution switchboard requires a complex study, and producing this switchboard is also complicated. Thus, there is a need for a distribution switchboard solution able to use standardised components, for which the design and installation effort is reduced.

### SUMMARY

To this end, the invention proposes a medium-voltage distribution switchboard, comprising:
a set of electrical cells, each electrical cell being configured to supply an electrical current,
a first communication bus,
a second communication bus distinct from the first communication bus,
a central unit connected to the first communication bus and to the second communication bus,
   each electrical cell respectively including:
a switching device suitable for interrupting the electrical current supplied by the electrical cell,
a first set of sensors, each sensor of the first set of sensors being configured to measure a first category of physical parameters representative of electrical energy supplied by the cell,
an interface unit connected to the first communication bus, the interface unit being configured to transmit to the central unit a measurement signal from each sensor of the first set of sensors,
a second set of sensors, each sensor of the second set of sensors being configured to measure a second category of physical parameters representative of operational conditions of the cell,
an acquisition unit connected to the second communication bus, the acquisition unit being configured to transmit to the central unit a measurement signal from each sensor of the second set of sensors,
   in which the central unit is configured to transmit an electrical current switching request to a cell of the set of electrical cells based on at least one signal among the signals transmitted by the interface unit of the said cell,
   in which the interface unit of each cell is configured to control respectively the switching device of the said cell upon reception of the electrical current switching request transmitted by the central unit,
   and in which the central unit is configured to assess an operational state of the distribution switchboard based on at least one signal among the measurement signals respectively transmitted by each acquisition unit.

The architecture proposed provides for constructing a distribution switchboard from components that are standardised and easy to configure. By using two separate communication buses, the execution of critical functions, such as the switching of the current in the event of a fault, can be ensured.

The features listed in the following paragraphs can be implemented independently of one another or according to all technically possible combinations:

The distribution switchboard forms a medium-voltage electrical distribution system.

According to one aspect of the distribution switchboard, the first communication bus is a bus dedicated to communications between the central unit and each interface unit of the set of electrical cells.

The operation of the first communication bus is independent of the operation of the second communication bus. The operation of the first communication bus, dedicated to critical functions, is thus secure.

The first communication bus is configured to establish communication only between the central unit and each interface unit of the set of electrical cells.

The first communication bus interconnects a first set of components, the first set of components consisting of the central unit and each interface unit of the set of electrical cells.

The first communication bus is a wired bus.

The first communication bus has a ring topology.

With this loop configuration, also referred to by the term “ring”, operation can be maintained even if a segment of the loop were to be interrupted.

Each measurement signal transmitted by each interface unit to the central unit is a digital signal.

According to another aspect of the distribution switchboard proposed, the second communication bus connects a second set of components, the second set of components comprising the central unit and each acquisition unit of the set of electrical cells.

The second communication bus connects the central unit and each acquisition unit of the set of electrical cells. The second communication bus can also connect other components.

The second communication bus is configured to establish communications only between the central unit and each acquisition unit of the set of electrical cells.

The measurement signal transmitted by each acquisition unit to the central unit is a digital signal.

According to one embodiment of the distribution switchboard, each cell comprises, respectively, an electrical conductor corresponding to a phase of a medium-voltage electrical network, and the first set of sensors of each electrical cell comprises at least one sensor among a current sensor and a voltage sensor.

The current sensor is configured to determine the intensity of the electrical current flowing in the electrical conductor.

The voltage sensor is configured to determine the electrical voltage of the electrical conductor.

By monitoring the intensity of the current flowing in the electrical conductor, or the voltage, an operational anomaly in the part of the electrical network powered by the cell can be determined.

According to an example embodiment, the first set of sensors of each electrical cell comprises a current sensor and a voltage sensor.

According to an example embodiment of the distribution switchboard, each cell respectively comprises three electrical conductors corresponding respectively to each of the phases of a medium-voltage electrical network, and the first set of sensors of each electrical cell comprises at least one sensor among an electrical current intensity sensor and an electrical voltage sensor for each phase.

According to one embodiment, the second set of sensors comprises at least one sensor among a temperature sensor, a pressure sensor, a moisture sensor and a partial discharge sensor.

More generally, the second set of sensors of a cell comprises any sensor for assessing the operational state of the corresponding cell.

These signals are for checking that the environmental conditions under which the electrical cell operates remain within acceptable limits. They are also for checking the operational state of the cell, i.e. to check that the equipment or components of the cell are not degraded.

Each sensor of the second set of sensors can respectively be arranged inside a cell.

Each sensor of the second set of sensors is for example fixed to a frame of the cell.

The first communication bus is configured to use a first digital communication protocol.

The first digital communication protocol is for example the IEC 61850 protocol.

This protocol enables the transmission of sampled signals with sufficient performance to provide the protection functions.

The second communication bus is configured to use a second digital communication protocol.

The second digital communication protocol can be different from the first digital communication protocol.

The second digital communication protocol is for example the Modbus protocol.

Other industrial protocols can also be used, notably CAN, CANopen, J1939, LIN, EtherCAT, Ethernet/IP and PROFINET.

The second communication bus is a wired bus.

The second communication bus has a bus topology.

According to one embodiment of the distribution switchboard, the interface unit of each electrical cell is configured to sample an analogue electrical signal supplied by each sensor of the first set of sensors, and to transmit the sampled values to the central unit via the first communication bus.

If the sensors used are analogue sensors, the interface unit performs the acquisition of the analogue signal and the analogue-to-digital conversion of the signal acquired beforehand.

According to an example embodiment of the distribution switchboard, the sampling is performed synchronously between the interface units of the set of electrical cells.

Monitoring algorithms based on the comparison of the signals from different cells can thus be implemented.

The interface units are thus configured to synchronously sample the analogue electrical signals supplied by the sensors of the first set of sensors.

The interface units are configured to sample the analogue electrical signals supplied by the sensors of the first set of sensors at a first predetermined frequency.

The first predetermined frequency is for example 4.8 kHz.

According to one embodiment of the distribution switchboard, the acquisition unit of each electrical cell is configured to sample an analogue electrical signal supplied by each sensor of the second set of sensors, and to transmit the sampled values to the central unit via the second communication bus,

According to one embodiment, the sampling is performed synchronously between the acquisition units of the set of electrical cells.

The acquisition units are configured to synchronously sample the analogue electrical signals supplied by the sensors of the second set of sensors.

According to one embodiment, the acquisition units are configured to sample the analogue electrical signals supplied by the sensors of the second set of sensors at a second predetermined frequency.

The second predetermined frequency is chosen as a function of the dynamics of the physical parameter observed. “Dynamics” is understood to mean the maximum speed of variation of the physical phenomenon observed.

According to one embodiment, the central unit is configured to:
analyse at least one signal among the signals transmitted by the interface unit of a cell,
detect an anomaly in the electrical current supplied by the said cell based on the at least one signal analysed.

For example, the central unit is configured to:
analyse the signal transmitted by the acquisition unit of a cell,
assess an operational state of the said cell based on each of the signals analysed.

According to one aspect of the distribution switchboard, the central unit is configured to:
detect an operational anomaly corresponding to a short-circuit in a cell of the set of electrical cells,
transmit an electrical current switching request to the cell for which an operational anomaly corresponding to a short-circuit is detected.

The central unit triggers the switching of the current in a cell when a critical event, such as a short-circuit, is detected for the cell concerned.

According to another aspect of the distribution switchboard, the central unit is configured to:
detect an operational anomaly corresponding to an overheating of a cell of the set of electrical cells,
transmit a warning signal indicating the cell for which an operational anomaly corresponding to an overheating is detected.

In the event of a non-critical event, a warning signal is transmitted without interrupting the operation of the cell concerned. The operator of the electrical network can thus analyse the operation of the system and take suitable corrective measures.

The first set of sensors of a cell of the set of cells is identical to the first set of sensors of the other cells of the set of cells.

The equipment of the cells can thus be at least partly standardised.

The second set of sensors of a cell of the set of cells is identical to the second set of sensors of the other cells of the set of cells.

As previously, the equipment of the cells can thus be at least partly standardised.

The interface unit of a cell of the set of cells is identical to the interface unit of the other cells of the set of cells.

The interface units of the set of electrical cells are identical.

The acquisition unit of a cell of the set of cells is identical to the acquisition unit of the other cells of the set of cells.

The acquisition units of the set of electrical cells are identical.

As previously, the equipment of the cells can thus be at least partly standardised.

According to an example embodiment of the distribution switchboard, all the cells of the set of electrical cells are identical.

It is understood that all the cells are physically identical. The distribution switchboard can thus be produced from entirely standardised cells. The implementation and the modification of an electrical network is thus made easier.

### BRIEF DESCRIPTION OF THE DRAWINGS

Other features, details and advantages will emerge upon reading the following detailed description, and upon examining the appended drawings in which:

FIG. 1 is a schematic representation of a medium-voltage distribution switchboard according to the invention,

FIG. 2 is a schematic representation of an electrical cell of the distribution switchboard of FIG. 1.

### DESCRIPTION OF EMBODIMENTS

To make the figures easier to read, the various components are not necessarily represented to scale. In these figures, identical components bear the same references. Certain components or parameters may be indexed, i.e. denoted for example by first component or second component, or first parameter and second parameter, etc. This indexing aims to differentiate components or parameters that are similar but not identical. This indexing does not imply priority of one component, or parameter, over another and the designations can be interchanged. When it is specified that a device includes a given component, that does not exclude the presence of other components in this device.

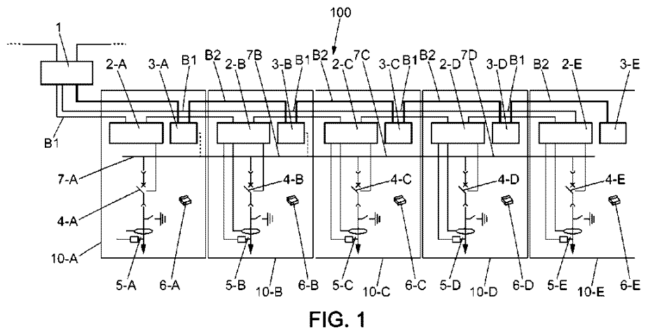

Represented in FIG. 1 is a medium-voltage distribution switchboard 100.

The distribution switchboard 100 comprises a set of electrical cells. In the description that follows, the terms “cell”and “electrical cell”are equivalent.

In the example illustrated, the distribution switchboard 100 comprises five electrical cells, denoted by the labels 10-A, 10-B, 10-C, 10-D, 10-E.

The number of cells represented has been chosen arbitrarily and the distribution switchboard 100 can include any number of cells.

To simplify the references used in the detailed description, only the first three cells 10-A, 10-B, 10-C will be mentioned as well as the corresponding equipment.

The medium-voltage distribution switchboard 100 proposed here comprises:
a set of electrical cells 10-A, 10-B, 10-C, each electrical cell 10-A, 10-B, 10-C being configured to supply an electrical current,
a first communication bus B1,
a second communication bus B2 distinct from the first communication bus B1,
a central unit 1 connected to the first communication bus B1 and to the second communication bus B2.

Each electrical cell 10-A, 10-B, 10-C respectively includes:
a switching device 4-A, 4-B, 4-C suitable for interrupting the electrical current supplied by the electrical cell 10-A, 10-B, 10-C,
a first set of sensors 5-A, 5-B, 5-C, each sensor of the first set of sensors 5-A, 5-B, 5-C being configured to measure a first category of physical parameters representative of electrical energy supplied by the cell 10-A, 10-B, 10-C,
an interface unit 2-A, 2-B, 2-C connected to the first communication bus B1, the interface unit 2-A, 2-B, 2-C being configured to transmit to the central unit 1 a measurement signal from each sensor of the first set of sensors 5-A, 5-B, 5-C,
a second set of sensors 6-A, 6-B, 6-C, each sensor of the second set of sensors 6-A, 6-B, 6-C being configured to measure a second category of physical parameters representative of operational conditions of the cell 10-A, 10-B, 10-C,
an acquisition unit 3-A, 3-B, 3-C connected to the second communication bus B2, the acquisition unit 3-A, 3-B, 3-C being configured to transmit to the central unit 1 a measurement signal from each sensor of the second set of sensors 6-A, 6-B, 6-C.

The central unit 1 is configured to transmit an electrical current switching request to a cell of the set of electrical cells 10-A, 10-B, 10-C based on at least one signal among the signals transmitted by the interface unit 2-A, 2-B, 2-C of the said cell 10-A, 10-B, 10-C.

The interface unit 2-A, 2-B, 2-C of each cell 10-A, 10-B, 10-C is configured to control respectively the switching device 4-A, 4-B, 4-C of the said cell 10-A, 10-B, 10-C upon reception of the electrical current switching request transmitted by the central unit 1.

The central unit 1 is configured to assess an operational state of the distribution switchboard 100 based on at least one signal among the measurement signals respectively transmitted by each acquisition unit 3-A, 3-B, 3-C.

The architecture proposed provides for constructing a distribution switchboard 100 from components that are standardised and easy to configure. The various cells form the standardised components. By using two separate communication buses, the execution of critical functions, such as the switching of the current in the event of a fault, can be ensured.

The distribution switchboard 100 proposed forms a medium-voltage electrical distribution system.

The distribution switchboard provides for supplying different branches of a medium-voltage electrical network.

The first set of sensors of a cell are for measuring physical parameters, or physical quantities, for monitoring the electrical energy supplied by this cell. This first category of physical parameters are the parameters involved in the detection of critical faults in the supply of electrical energy, such as a short-circuit in a network branch supplied by this cell.

The first category of physical parameters is thus at the root of the detection of critical faults in the supply of electrical energy.

The second set of sensors of a cell are for measuring physical parameters, or physical quantities, for monitoring the conditions under which this cell operates. This second category of physical parameters are the parameters involved in the monitoring of the operation of the cell, excluding critical faults that require an almost immediate corrective action.

The second category of physical parameters notably provides for carrying out medium-term or long-term monitoring of the operation of the cell.

The first communication bus B1 is a bus dedicated to communications between the central unit 1 and each interface unit 2-A, 2-B, 2-C of the set of electrical cells 10-A, 10-B, 10-C.

The operation of the first communication bus B1 is thus independent of the operation of the second communication bus B2. The operation of the first communication bus B1, dedicated to critical functions, is thus secure. The switching of the current in the event of a short-circuit in a cell is an example of a critical function.

The first communication bus B1 is thus configured to establish communications only between the central unit 1 and each interface unit 2-A, 2-B, 2-C of the set of electrical cells 10-A, 10-B, 10-C.

In other words, the first communication bus B1 is closed to the external environment.

The first communication bus B1 connects only the central unit 1 and each interface unit 2-A, 2-B, 2-C of the set of electrical cells 10-A, 10-B, 10-C.

In other words, the first communication bus B1 interconnects a first set of components, the first set of components consisting of the central unit 1 and each interface unit 2-A, 2-B, 2-C of the set of electrical cells 10-A, 10-B, 10-C.

The first communication bus B1 is a wired bus.

The first communication bus B1 has a ring topology.

In other words, the first communication bus B1 has a loop structure.

With this loop configuration, operation can be maintained even if a segment of the loop were to be interrupted.

The first communication bus B1 connects the central unit 1 to the interface unit 2-A of the first cell 10-A. The first communication bus B1 connects the central unit 1 to the interface unit of the last cell.

For a set of cells comprising N cells, the interface unit of a cell of given rank k between 2 and N−1 is connected, or linked, to the interface unit of the cell of immediately lower rank k−1 and to the interface unit of the cell of immediately higher rank k+1.

For example, in a distribution switchboard having exactly five cells, as in the example of FIG. 1, the central unit 1 is connected to the interface unit 2-A of the first cell 10-A and to the interface unit 2-E of the fifth and last cell 10-E.

The interface unit 2-B of the second cell 10-B is thus connected to the interface unit 2-A of the first cell 10-A and to the interface unit 2-C of the third cell 10-C.

From the second cell 10-B to the penultimate cell 10-D, each interface unit is connected to the interface unit of the cell of immediately lower rank, i.e. the interface unit of the preceding cell, and to the interface unit of the cell of immediately higher rank, i.e. the interface unit of the next cell.

Each measurement signal transmitted by each interface unit 2-A, 2-B, 2-C to the central unit 1 is a digital signal.

The second communication bus B2 connects a second set of components, the second set of components comprising the central unit 1 and each acquisition unit 3-A, 3-B, 3-C of the set of electrical cells 10-A, 10-B, 10-C.

The second communication bus B2 thus connects the central unit 1 and each acquisition unit 3-A, 3-B, 3-C of the set of electrical cells 10-A, 10-B, 10-C.

The second communication bus B2 can also connect other components.

For example, a frame reader, for reading and decoding the information transmitted, can be connected to the second communication bus B2. An operator can thus temporarily connect to the second communication bus B2 in order to read the measurement quantities transmitted by one or more of the acquisition units 3-A, 3-B, 3-C.

The second communication bus B2 is configured to establish communications notably between the central unit 1 and each acquisition unit 3-A, 3-B, 3-C of the set of electrical cells 10-A, 10-B, 10-C.

The measurement signal transmitted by each acquisition unit 3-A, 3-B, 3-C to the central unit 1 is a digital signal.

Each acquisition unit 3-A, 3-B, 3-C acquires the measurement signal from each of the measurement sensors of the second set of sensors 6-A, 6-B, 6-C. When this signal is an analogue signal, the acquisition unit performs the analogue-to-digital conversion of the measurement signal, and transmits the converted signal over the second communication bus B2.

As shown schematically in FIG. 1, each cell 10-A, 10-B, 10-C respectively comprises an electrical conductor 7-A, 7-B, 7-C corresponding to a phase L1 of a medium-voltage electrical network, and the first set of sensors 5-A, 5-B, 5-C of each electrical cell 10-A, 10-B, 10-C comprises at least one sensor among a current sensor and a voltage sensor.

The current sensor is configured to determine the intensity of the electrical current flowing in the electrical conductor 7-A, 7-B, 7-C.

The voltage sensor is configured to determine the electrical voltage of the electrical conductor 7-A, 7-B, 7-C.

By monitoring the intensity of the current flowing in the electrical conductor of a given cell, and/or the electrical voltage, an operational anomaly in the part of the electrical network powered by this cell can be determined.

According to an example embodiment, the first set of sensors 5-A, 5-B, 5-C of each electrical cell 10-A, 10-B, 10-C comprises a current sensor and a voltage sensor.

In other words, the intensity of the electrical current and the voltage are both measured in order to monitor the current in the cell.

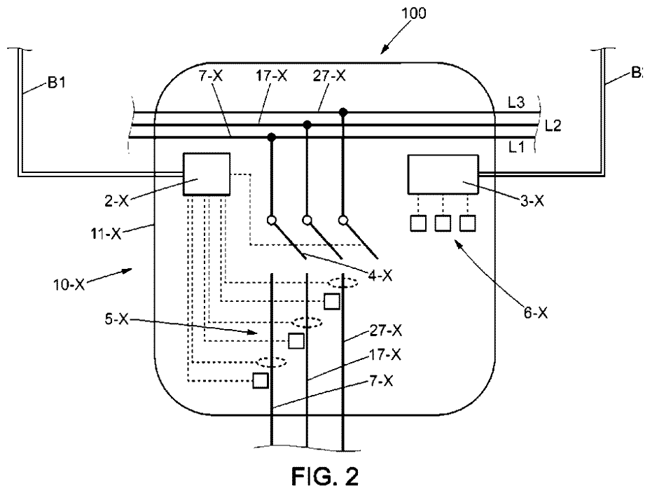

FIG. 2 schematically represents an electrical cell taken in isolation. This cell is denoted by the label 10-X. This designation is generic in order to denote any of the cells 10-A, 10-B, 10-C, 10-D, 10-E illustrated in FIG. 1. In other words, the reference “X” can denote any of the labels “A”, “B”, “C”, “D”, “E”of FIG. 1.

The electrical conductors corresponding to the two other phases L2, L3 of the three-phase network are equipped in a manner similar to the electrical conductor corresponding to the first phase L1.

Thus, each cell 10-X respectively comprises three electrical conductors 7-X, 17-X, 27-X corresponding respectively to each of the phases L1, L2, L3 of a medium-voltage electrical network.

The first set of sensors 5-A, 5-B, 5-C of each electrical cell 10-A, 10-B, 10-C comprises at least one sensor among an electrical current intensity sensor and an electrical voltage sensor for each phase L1, L2, L3.

The second set of sensors 6-A, 6-B, 6-C comprises at least one sensor among a temperature sensor, a pressure sensor, a moisture sensor and a partial discharge sensor.

More generally, the second set of sensors 6-A, 6-B, 6-C of a cell 10-A, 10-B, 10-C comprises any sensor for assessing the operational state of the corresponding cell.

“Assessing the operational state of the cell” is understood to mean determining the conditions under which the cell is operating. This operational state is different from the state of the network branch powered by this cell.

The signals delivered by the various sensors of the second set of sensors 6-A, 6-B, 6-C provide for checking that the environmental conditions under which each electrical cell operates remain within acceptable limits. They also provide for checking that the equipment or components of each cell are not degraded. They also provide for detecting an operational anomaly such as a degradation of one or more items of equipment of each cell. With this monitoring, maintenance can be planned if necessary.

Each cell 10-X comprises a frame, not represented, supporting a set of panels delimiting an enclosure 11-X. The various items of equipment in the cell are arranged inside the enclosure 11-X.

“Equipment” is understood to mean notably the various sensors, the switching device, the interface unit, the acquisition unit, as well as the associated cables and connectors, and the associated fixing devices.

A movable panel, not represented, provides for opening and closing the enclosure 11-X, in particular for maintenance operations.

Each sensor of the second set of sensors 6-A, 6-B, 6-C is thus arranged, respectively, inside a cell 10-A, 10-B, 10-C.

Each sensor of the second set of sensors 6-A, 6-B, 6-C is for example fixed to a frame of the cell 10-A, 10-B, 10-C.

A temperature sensor provides for measuring the temperature inside the cell 10-X. By measuring this internal temperature of a cell 10-X, abnormal overheating can be detected.

A pressure sensor provides for measuring the pressure prevailing inside the cell, when the latter comprises a pressurised sealed enclosure. By measuring this pressure, a possible leakage from the pressurised enclosure of the cell can be detected.

A moisture sensor provides for measuring the moisture content of the air, or of the gas, inside the enclosure of the cell. An abnormal water vapour content can thus be detected.

A partial discharge sensor provides for detecting the occurrence of partial discharges in the cell, i.e. transient electric arcs.

The first communication bus B1 is configured to use a first digital communication protocol.

The first digital communication protocol is for example the IEC 61850 protocol.

This protocol enables the transmission of sampled signals with sufficient performance to provide the protection functions.

The second communication bus B2 is configured to use a second digital communication protocol,

The second digital communication protocol can be different from the first digital communication protocol.

The second digital communication protocol is for example the Modbus protocol. Other industrial protocols can also be used, notably CAN, CANopen, J1939, LIN, EtherCAT, Ethernet/IP and PROFINET.

The second communication bus B2 is a wired bus.

The second communication bus B2 has a bus topology.

Thus, the second communication bus B2 connects the central unit 1 to the acquisition unit 3-A of the first cell 10-A. The second communication bus B2 connects the acquisition unit 3-A of the first cell 10-A to the acquisition unit 3-B of the second cell 10-B.

For a set of cells comprising N cells, the acquisition unit of a cell of given rank k between 2 and N−1 is connected to the acquisition unit of the cell of immediately lower rank k−1 and to the acquisition unit of the cell of immediately higher rank k+1.

In other words, from the second cell 10-B to the penultimate cell 10-D, each acquisition unit is connected to the acquisition unit of the preceding cell, and to the acquisition unit of the next cell.

The interface unit 2-X of a cell X performs several functions: acquiring measurements from sensors 5-X monitoring the electrical current, digitising these measurements if necessary, and transmitting this data to the central unit 1.

Furthermore, the interface unit 2-X comprises an actuator, not represented, for triggering the switching device 4-X of the cell 10-X.

The interface unit 2-A, 2-B, 2-C of each electrical cell 10-A, 10-B, 10-C is configured to sample an analogue electrical signal supplied by each sensor of the first set of sensors 5-A, 5-B, 5-C, and to transmit the sampled values to the central unit 1 via the first communication bus B1.

If the sensors used are analogue sensors, the interface unit performs the acquisition of the analogue signal and then the analogue-to-digital conversion of the acquired signal.

When the first set of sensors of a cell comprises a current sensor and a voltage sensor, the interface unit performs the acquisition and the conversion of the signal from the current sensor, and the acquisition and the conversion of the signal from the voltage sensor.

If at least one of the sensors used is a sensor supplying a digital signal, the interface unit transmits the supplied signal without processing.

According to an example embodiment of the distribution switchboard 100, the sampling is performed synchronously between the interface units 2-A, 2-B, 2-C of the set of electrical cells 10-A, 10-B, 10-C.

In other words, the sampling of the signal takes place at the same instant for all the interface units 2-A, 2-B, 2-C. After a sampling period, a new sample is taken for each interface unit of the set of interface units.

Monitoring algorithms based on the comparison of the signals from different cells can thus be implemented.

This is because the algorithms based on the consistency between the various cells of the value of a given signal generally require that the various samples are measured at the same instant.

The interface units 2-A, 2-B, 2-C are thus configured to synchronously sample the analogue electrical signals supplied by the sensors of the first set of sensors 5-A, 5-B, 5-C.

The interface units 2-A, 2-B, 2-C are configured to sample the analogue electrical signals supplied by the sensors of the first set of sensors 5-A, 5-B, 5-C at a first predetermined frequency.

The first predetermined frequency is for example 4.8 kHz.

The acquisition unit 3-X of a cell X also performs several functions: acquiring measurements from sensors of the second set of sensors 6-X, processing them and transmitting them to the central unit 1.

The acquisition unit 3-A, 3-B, 3-C of each electrical cell 10-A, 10-B, 10-C is configured to sample an analogue electrical signal supplied by each sensor of the second set of sensors 6-A, 6-B, 6-C, and to transmit the sampled values to the central unit 1 via the second communication bus B2.

According to one embodiment, the sampling is performed synchronously between the acquisition units 3-A, 3-B, 3-C of the set of electrical cells 10-A, 10-B, 10-C.

The acquisition units 3-A, 3-B, 3-C are configured to synchronously sample the analogue electrical signals supplied by the sensors of the second set of sensors 6-A, 6-B, 6-C.

According to one embodiment, the acquisition units 3-A, 3-B, 3-C are configured to sample the analogue electrical signals supplied by the sensors of the second set of sensors 6-A, 6-B, 6-C at a second predetermined frequency.

The second predetermined frequency is different from the first predetermined frequency.

The second predetermined frequency is chosen as a function of the dynamics of the physical parameter observed. “Dynamics” is understood to mean the maximum speed of variation of the physical phenomenon observed.

The temperature inside the cell and the pressure inside the cell have variation dynamics that are slower than that of current; the second sampling frequency can therefore be lower than the first sampling frequency.

The signals from the various sensors of the second set of sensors 6-X can also be sampled at different frequencies. The sampling frequency of each sensor is tailored to the maximum speed of variation of the physical quantity measured by the sensor in question.

The acquisition unit 3-X of a cell X performs the acquisition of measurements from sensors 6-X monitoring operational conditions of the cell, digitising these measurements if necessary, and transmitting the digital data to the central unit 1.

The acquisition unit 3-X does not have an actuator.

The central unit 1 receives the information sent by the various interface units and acquisition units, and acts as supervisor of the operation of the distribution switchboard 100.

The central unit 1 is arranged outside the electrical cells, and can be remote from the electrical cells.

The central unit 1 receives a first set of information concerning the energy in each of the electrical phases of the cell, from the sensors of the first set of sensors. The central unit 1 also receives a second set of information concerning the operational conditions, from the sensors of the second set of sensors. The central unit executes monitoring and fault detection algorithms based on the sets of information received. If necessary, the central unit 1 can control the circuit breaker of the cell for which a critical fault is detected, via the interface unit of this cell. The central unit 1 can also carry out other actions, such as transmitting warning signals.

The central unit 1 is thus configured to:
analyse at least one signal among the signals transmitted by the interface unit 2-A, 2-B, 2-C of a cell 10-A, 10-B, 10-C,
detect an anomaly in the electrical current supplied by the said cell 10-A, 10-B, 10-C based on the at least one analysed signal.

For each cell, the analysed signal is for example the intensity of the electrical current.

The central unit 1 is also configured to:
analyse the signal transmitted by the acquisition unit 3-A, 3-B, 3-C of a cell 10-A, 10-B, 10-C,
assess an operational state of the said cell 10-A, 10-B, 10-C based on each of the analysed signals.

The central unit 1 is configured to:
detect an operational anomaly corresponding to a short-circuit in a cell of the set of electrical cells 10-A, 10-B, 10-C,
transmit an electrical current switching request to the cell for which an operational anomaly corresponding to a short-circuit is detected.

The operational anomaly is in this case an anomaly in the electrical current supplied.

The central unit 1 triggers the switching of the current in a cell when a critical operational anomaly, such as a short-circuit, is detected for the network branch monitored by this cell. Indeed, such a fault in the network must be addressed with without delay so as not to risk degradation of all or some of the components of the branch being monitored.

The central unit 1 thus provides a protective function for the electrical network.

The central unit 1 is also configured to:
detect an operational anomaly corresponding to an overheating of a cell of the set of electrical cells 10-A, 10-B, 10-C,
transmit a warning signal indicating the cell for which an operational anomaly corresponding to an overheating is detected.

In the event of a non-critical operational anomaly, such as moderate overeating, a warning signal is transmitted without however interrupting the operation of the cell concerned. The operator of the electrical network can thus analyse the operation of the system and take suitable corrective measures.

The warning signal can be a visual signal on a monitor, or an audible signal, or a message sent to portable equipment used by the operator of the electrical network.

The architecture proposed for the distribution switchboard 100 provides for standardising cells.

The first set of sensors 5-X of a cell of the set of cells 10-A, 10-B, 10-C can be identical to the first set of sensors of the other cells of the set of cells 10-A, 10-B, 10-C.

The sensors of the first set of sensors are the same model on each cell. For example, the current sensor is the same for all the cells. Similarly, the voltage sensor can be the same model for all the cells. The equipment of the cells can thus be at least partly standardised.

Similarly, the second set of sensors 6-X of a cell of the set of cells 10-A, 10-B, 10-C can be identical to the second set of sensors of the other cells of the set of cells 10-A, 10-B, 10-C.

The second sets of sensors are identical. In other words, the sensors of the second set of sensors are the same model on each cell.

As previously, the equipment of the cells can thus be at least partly standardised.

The standardisation can be applied also to the interface units and the acquisition units.

Preferably, the interface unit 2-X of a cell of the set of cells 10-A, 10-B, 10-C is identical to the interface unit of the other cells of the set of cells 10-A, 10-B, 10-C.

The interface units of the set of electrical cells 10-A, 10-B are thus identical.

Also preferably, the acquisition unit 3-A, 3-B, 3-C of a cell of the set of cells 10-A, 10-B, 10-C is identical to the acquisition unit of the other cells of the set of cells 10-A, 10-B, 10-C.

The acquisition units 3-A, 3-B, 3-C of the set of electrical cells 10-A, 10-B, 10-C are identical.

As previously, the equipment of the cells can thus be at least partly standardised.

According to an example embodiment of the distribution switchboard 100, all the cells of the set of electrical cells 10-A, 10-B, 10-C are identical.

It is understood that all the cells are identical in terms of hardware.

In other words, the cells can be completely standardised, both in their mechanical parts and in their electrical equipment.

Production of the cells is thus made easier. Furthermore, the implementation and the modification of an electrical network is thus made easier.

The standardisation can also be applied to the software used.

The interface unit of a cell can have the same software as the interface unit of the other cells of the set of cells. The software can thus also be standardised. Configuration of the software of the interface unit may differ from one cell to another.

Similarly, the acquisition unit of a cell can have the same software as the acquisition unit of the other cells of the set of cells.

Similarly, configuration of the software of the acquisition unit may differ from one cell to another.

1. A medium-voltage distribution switchboard, comprising:
a set of electrical cells, each electrical cell being configured to supply an electrical current,
a first communication bus,
a second communication bus distinct from the first communication bus,
a central unit connected to the first communication bus and to the second communication bus,
each electrical cell respectively including:
a switching device suitable for interrupting the electrical current supplied by the electrical cell
a first set of sensors, each sensor of the first set of sensors being configured to measure a first category of physical parameters representative of electrical energy supplied by the cell,
an interface unit connected to the first communication bus, the interface unit being configured to transmit to the central unit a measurement signal from each sensor of the first set of sensors,
a second set of sensors each sensor of the second set of sensors being configured to measure a second category of physical parameters representative of operational conditions of the cell,
an acquisition unit connected to the second communication bus, the acquisition unit being configured to transmit to the central unit a measurement signal from each sensor of the second set of sensors,
in which the central unit is configured to transmit an electrical current switching request to a cell of the set of electrical cells based on at least one signal among the signals transmitted by the interface unit of the said cell,
in which the interface unit of each cell is configured to control respectively the switching device of the said cell upon reception of the electrical current switching request transmitted by the central unit,
and in which the central unit is configured to assess an operational state of the distribution switchboard based on at least one signal among the measurement signals respectively transmitted by each acquisition unit.

2. Distribution The distribution switchboard according to claim 1, in which the first communication bus is a bus dedicated to communications between the central unit and each interface unit of the set of electrical cells.

3. Distribution switchboard according to claim 1, in which the second communication bus connects a second set of components, the second set of components comprising the central unit and each acquisition unit of the set of electrical cells.

4. The distribution switchboard according to claim 1, in which each cell respectively comprises an electrical conductor corresponding to a phase of a medium-voltage electrical network, and in which the first set of sensors of each electrical cell comprises at least one sensor among a current sensor and a voltage sensor.

5. The distribution switchboard according to claim 1, in which the second set of sensors comprises at least one sensor among temperature sensor, a pressure sensor, a moisture sensor and a partial discharge sensor.

6. The distribution switchboard according to claim 1, in which the first communication bus is configured to use a first digital communication protocol,
and in which the second communication bus is configured to use a second digital communication protocol.

7. The distribution switchboard according to claim 1, in which the interface unit of each electrical cell is configured to sample an analogue electrical signal supplied by each sensor of the first set of sensors, and to transmit the sampled values to the central unit via the first communication bus,
and in which the sampling is performed synchronously between the interface units of the set of electrical cells.

8. The distribution switchboard according to claim 1, in which the acquisition unit of each electrical cell is configured to sample an analogue electrical signal supplied by each sensor of the second set of sensors, and to transmit the sampled values to the central unit via the second communication bus.

9. The distribution switchboard according to claim 1, in which the central unit is configured to:
analyse at least one signal among the signals transmitted by the interface unit of a cell,
detect an anomaly in the electrical current supplied by the said cell based on the at least one signal analysed.

10. The distribution switchboard according to claim 1, in which the central unit is configured to:
analyse the signal transmitted by the acquisition unit of a cell,
assess an operational state of the said cell based on each of the signals analysed.

11. The distribution switchboard according to claim 9, in which the central unit is configured to:
detect an operational anomaly corresponding to a short-circuit in a cell of the set of electrical cells,
transmit an electrical current switching request to the cell for which an operational anomaly corresponding to a short-circuit is detected.

12. Distribution The distribution switchboard according to claim 9, in which the central unit is configured to:
detect an operational anomaly corresponding to an overheating of a cell of the set of electrical cells,
transmit a warning signal indicating the cell for which an operational anomaly corresponding to an overheating is detected.

13. The distribution switchboard according to claim 1, in which all the cells of the set of electrical cells are identical.
